(19) United States
(12) Patent Application Publication
(10) Pub. No.: US 2016/0326419 A1
(43) Pub. Date: Nov. 10, 2016

(54) THERMAL INTERFACE MATERIALS WITH ALLIGNED FILLERS

(71) Applicant: The Regents of The University of California, Oakland, CA (US)

(72) Inventor: Alexander A. Balandin, Riverside, CA (US)

(73) Assignee: The Regents of The University of California, Oakland, CA (US)

(21) Appl. No.: 15/109,072

(22) PCT Filed: Dec. 31, 2014
(86) PCT No.: PCT/US14/73085

§ 371 Date: Jun. 29, 2016

Related U.S. Application Data
(60) Provisional application No. 61/922,225, filed on Dec. 31, 2013.

(51) Int. Cl. C09K 5/14; H01F 1/44; C09D 163/00; C09D 7/12

(52) U.S. Cl. CPC C09K 5/14; C09D 7/1291; H01F 1/445; C09D 163/00; C08K 7/00

(57) ABSTRACT

Thermal interface materials and methods are disclosed. The thermal interface material can include a matrix and fillers. The filler can include magnetically functionalized graphene flakes that are disposed and aligned within the matrix. The method can include providing or obtaining the magnetically functionalized graphene flakes and aligning the magnetically functionalized graphene flakes from a random orientation to a specific origination while dispersing the thermal interface material onto a substrate.

### CROSS-REFERENCE TO RELATED APPLICATIONS

This application claims the benefit of U.S. Provisional Patent Application No. 61/922,225, filed Dec. 31, 2013, the benefit of priority of which is claimed hereby, and which is incorporated by reference herein in its entirety.

### TECHNICAL FIELD

This document pertains generally, but not by way of limitation, to thermal interface materials (TIMs) used for heat removal in various applications, e.g., electronics, optoelectronics, photonics, and battery technology.

### BACKGROUND

Thermal interface materials are essential ingredients of packaging of electronics, for example, computer chips, communication devices, and electronic circuits. Rapidly increasing power densities in electronics make efficient heat removal an important issue for progress in information, communication, and energy storage technologies. Development of the next generations of integrated circuits (ICs), three-dimensional (3D) integration and ultra-fast high-power density communication devices can make the thermal management requirements extremely severe.

Efficient heat removal can become a critical issue for the performance and reliability of modern electronic, optoelectronic, photonic devices, and systems. Thermal interface materials (TIMs), applied between heat sources and heat sinks, can be essential ingredients of thermal management. Conventional TIMs filled with thermally conductive particles require high volume fractions f of filler (f about 50 percent (%)) to achieve thermal conductivity (K) of the composite in the range of about 1-5 Watts per meter per Kelvin (W/mK) at room temperature (RT, approximately 20 degrees Celsius (° C.). Attempts of utilizing highly thermally conductive nanomaterials, e.g., carbon nanotubes (CNTs), as fillers in TIMs, have not led to practical applications due to weak thermal coupling at CNTs/base interface and prohibitive cost.

### SUMMARY

The present inventor recognizes, among other things, that increasing the thermal conductivity of TIMs could produce a major impact on thermal management of various devices resulting in improved performance, reliability and reduced energy consumption. The present disclosure provides, in certain aspects, a thermal interface material that includes a matrix and a filler. The filler includes magnetically functionalized graphene flakes that are can be aligned into a specific orientation within the matrix. The TIM of the present disclosure has an increased thermal conductivity as compared to current TIMs, while maintaining other characteristics of the TIM such as viscosity, bond line thickness, thermal contact resistance Rc, temperature expansion coefficient (TEC) and cost, within industry standards.

To further illustrate the thermal interface materials, devices, and methods disclosed herein, a non-limiting list of examples is provided here:

In Example 1, a method includes obtaining or forming a thermal interface material including a matrix and a filler, the filler including magnetically functionalized graphene flakes arranged in in a random orientation; depositing the thermal interface material onto a mating substrate; and applying a magnetic field to the thermal interface material to align the magnetically functionalized graphene flakes into a specific orientation with respect to the mating substrate.

In Example 2, the Example of 1 can be optionally configured such that forming the thermal interface material includes combining a primer and a graphene solution including graphene flakes to form a primer solution; combining a cationic polyelectrolyte and the primer solution to form a charged graphene solution; and combining magnetic nanoparticles and the charged graphene solution to form a magnetic solution.

In Example 3, Example 2 can be optionally configured to include mixing the magnetic solution and the matrix to form the thermal interface material including the magnetically functionalized graphene flakes.

In Example 4, Example 2 can be optionally configured to such that the matrix material is selected from one of a polymer, an epoxy, and thermal grease.

In Example 5, any one or any combination of Examples 2-4 can be optionally configured to such that the primer is poly-sodium-4-styrene-sulfonate and the cationic polyelectrolyte is poly-dimethyl-diallylammonium chloride.

In Example 6, any one or any combination of Examples 1-5 can be optionally configured to include providing or obtaining a magnet on an assembly desk, and placing the mating substrate on a top surface of the magnet.

In Example 7, any one or any combination of Examples 1-6 can be optionally configured such that the magnetic field is applied to the thermal interface material simultaneously as the thermal interface material is deposited onto the mating substrate.

In Example 8, any one or any combination of Examples 1-7 can be optionally configured such that the magnetic field is applied to the thermal interface material after the thermal interface material is deposited onto the mating substrate.

In Example 9, any one or any combination of Examples 1-8 can be optionally configured such that when the magnetically functionalized graphene flakes are in the specific orientation, a majority of the magnetically functionalized graphene flakes are substantially perpendicular to the top surface of the mating substrate.

In Example 10, any one or any combination of Examples 1-9 can be optionally configured such that the mating substrate is a first mating substrate, the method further includes waiting a time period to allow for partial solidification of the layer of the thermal interface material, and depositing a second mating substrate onto a top surface of the layer of the thermal interface material.

In Example 11, a device includes a first mating substrate having a top surface; a second mating substrate having a bottom surface; and a thermal interface material positioned between and in direct contact with the top surface of the first mating substrate and the bottom surface of the second mating substrate, the thermal interface material including a matrix; and a filler including magnetically functionalized graphene flakes, the magnetically functionalized graphene flakes arranged in a specific orientation with respect to the top surface and the bottom surface.

In Example 12, Example 11 can be optionally configured such that the thermal interface material includes the magnetically functionalized graphene flakes within a range of about 0.5 volume percent to about 25 volume percent, based on a total volume of the thermal interface material.

In Example 13, any one or any combination of Examples 11 and 12 can be optionally configured such that a length of the magnetically functionalized graphene flakes is within a range of about 10 nanometers to about 100 micrometers micrometer to about 25 nanometers.

In Example 14, any one or any combination of Examples 11-13 can be optionally configured such that a thickness of the magnetically functionalized graphene flakes is within a range of about 0.35 nanometers to about 100 nanometers.

In Example 15, any one or any combination of Examples 11-14 can be optionally configured such that wherein 10 percent of the magnetically functionalized graphene flakes have a thickness below 0.7 nanometers, 50 percent of the magnetically functionalized graphene flakes have a thickness below 2 nanometers, and 40 percent of the magnetically functionalized graphene flakes have a thickness below 10 nanometers.

In Example 16, any one or any combination of Examples 11-15 can be optionally configured such that the magnetically functionalized graphene flakes includes magnetic nanoparticles, the magnetic nanoparticles having a diameter within a range of about 6 micrometers to about 10 micrometers.

In Example 17, a thermal interface composition includes a matrix and a filler material including magnetically functionalized graphene flakes arranged in a random orientation, the magnetically functionalized graphene flakes configured to align into a specific orientation with respect to a substrate when a magnetic field is applied to the thermal interface composition.

In Example 18, Example 17 can be optionally configured such the thermal interface composition includes the magnetically functionalized graphene flakes within a range of about 0.5 volume percent to about 25 volume percent, based on a total volume of the matrix and the filler material.

In Example 19, any one or any combination of Examples 17 and 18 can be optionally configured such that the magnetically functionalized graphene flakes include magnetic nanoparticles having a diameter within a range of about 6 nanometers to about 10 nanometers.

In Example 20, any one or any combination of Examples 17-19 can be optionally configured such that 10 percent of the magnetically functionalized graphene flakes have a thickness below 0.7 nanometers, 50 percent of the magnetically functionalized graphene flakes have a thickness below 2 nanometers, and 40 percent of the magnetically functionalized graphene flakes have a thickness below 10 nanometers.

Each of these non-limiting examples can stand on its own, or can be combined in various permutations or combinations with one or more of the other examples.

### BRIEF DESCRIPTION OF THE DRAWINGS

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

FIG. 1 illustrates a schematic illustrating the action of a thermal interface material, as constructed in accordance with at least one embodiment.

FIG. 2A illustrates an example of a thermal interface material including magnetically functionalized graphene flakes in a random orientation, as constructed in accordance with at least one embodiment.

FIG. 2B illustrates an example of a thermal interface material including magnetically functionalized graphene flakes in a specific orientation, as constructed in accordance with at least one embodiment.

FIG. 3 illustrates a cross-sectional view of an example packaging architecture for a personal computer including a thermal interface material, as constructed in accordance with at least one embodiment.

FIG. 4 illustrates a method, as constructed in accordance with at least one embodiment.

FIGS. 5A-5F illustrate an example method of assembly. FIG. 5A illustrates an example of an assembly desk and a magnet, as constructed in accordance with at least one embodiment.

FIG. 5B illustrates an example of a first substrate placed on top of the magnet as constructed in accordance with at least one embodiment.

FIG. 5C illustrates an example of a thermal interface material including the magnetically functionalized graphene flakes in a random orientation, as constructed in accordance with at least one embodiment.

FIG. 5D illustrates an example of the thermal interface material in FIG. 5C deposited onto the first substrate, where the magnetically functionalized graphene flakes have been aligned to have a specific orientation, as constructed in accordance with at least one embodiment.

FIG. 5E illustrates an example of a second substrate being placed onto a surface of the thermal interface material, as constructed in accordance with at least one embodiment.

FIG. 5F illustrates an example of a second substrate being placed onto the surface of the thermal interface material after the magnet has been removed, as constructed in accordance with at least one embodiment.

FIG. 6 illustrates a photograph of graphene fillers including graphene-graphite fillers aligned by a magnetic field.

FIG. 7 illustrates a scanning electron microscopy (SEM) image of a graphene flake with attached magnetic nanoparticles.

FIG. 8 illustrates a SEM image of the magnetically functionalized graphene flakes aligned within an epoxy matrix.

FIG. 9 illustrates a SEM image of an epoxy-based thermal interface material with magnetically functionalized graphene flakes arranged in a random orientation.

FIG. 10 illustrates a SEM image of the epoxy-based thermal interface material with the magnetically functionalized graphene flakes arranged in a specific orientation.

FIG. 11 illustrates the thermal diffusivity of Example 1, Comparative Example A, and Comparative Example B.

FIG. 12 illustrates the thermal conductivity of Example 1, Comparative Example A, and Comparative Example B.

FIG. 13 illustrates the thermal diffusivity of Example 2, Comparative Example C, and Comparative Example D.

FIG. 14 illustrates the thermal conductivity ratio of Example 2 and Comparative Example C.

FIG. 15 illustrates the thermal conductivity of Example 3 and Comparative Example E.

FIG. 16 illustrates the thermal conductivity of Example 4.

FIG. 17 illustrates the apparent thermal conductivity of Example 5, Example 6, and Comparative Example F.

FIG. 18 illustrates the apparent thermal conductivity of Example 5, Comparative Example F, and Comparative Example G.

FIG. 19 illustrates the temperature rise as a function of hours for Example 1, Comparative Example B, Comparative Example H, and Comparative Example I.

### DETAILED DESCRIPTION

This present disclosure provides a thermal interface material (TIM) with self-aligning graphene fillers and innovative technology for TIM dispersion in industrial environments. Efficient thermal management is one of the most important requirements for further progress in computer and communication technologies. Growing densities of dissipated heat require new types of TIMs for device and chip packages. Commercial TIMs reveal thermal conductivity (TC) in the range from 0.5 to 10 watts per meter kelvin (W/mK). TC enhancement is achieved via alignment of magnetized functionalized graphene flakes, which act as fillers in TIM matrix. Graphene has the highest TC of all known materials. The key aspect of the innovation is alignment of fillers with an external magnetic field during TIM dispersion. The inexpensive liquid-phase exfoliated graphene flakes are functionalized with the magnetic nanoparticles to enable the alignment.

In general, TIMs are composites, which include a polymer matrix or base material and thermally conductive filler particles. TIMs generally have to be mechanical stable, reliable, non-toxic, low-cost, and easy to apply. TIMs should generally possess as high thermal conductivity as possible, as well as low viscosity, and coefficient of thermal expansion.

The performance metric of TIM is its thermal resistance, R_{TIM}, with specific mating surfaces R_{TIM}=BLT/K+R_{C1}+R_{C2}, where K is the affective or apparent TC of TIM, BLT is the bond line thickness and R_{C1,2} are the TIM's contact resistance with the two bounding surfaces. The magnitude of R_{TIM} depends on TC, BLT, and R_{C} which are affected by surface roughness, temperature T, and viscosity.

The efficiency of the filler in TIMs can be characterized by the thermal conductivity enhancement (TCE) defined as η=(K−Kₘ)/Kₘ, where K is thermal conductivity of the composite and Kₘ is thermal conductivity of the matrix material. TCE of ˜170% at the 50% loading of conventional fillers such as silver or alumina with the filler particle size L<10 μm can be considered as standard.

In general, heat removal improves with higher thermal conductivity K, and smaller bond line thickness BLT and contact resistance R_{C1}, R_{C2} of the material. More efficient TIMs, which are used to minimize the thermal resistance between two surfaces can help to significantly lower the average and hot-spot temperatures in ICs, photovoltaic solar cells and batteries. Achieving enhancement of TIMs' thermal conductivity by a factor of 10-20 compared to that of the matrix materials can revolutionize not only electronics but also renewable energy generation where temperature rise in solar cells degrades the performance and limits life-time.

TIMs can be classified into the electrically insulating, e.g. silicone, plastics, phase change material (PCM) and the electrically conductive, e.g. greases with large metal particle loading. In addition, parameters such as chemical stability, surface properties with minimum surface deviations, mechanical tolerances, softness and flexibility, easy handling the economic efficiency have to meet the industry requirements. The environmental compatibility, suitability to adhesive, chemical, temperature and aging resistance, as well as lifetime are other important factors. These requirements limit the type of materials, which can be used as fillers in TIMs.

Previous approaches have considered carbon nanotubes (CNTs) as potential fillers for TIMs. Their main attractive feature was their extremely high intrinsic thermal conductivity Kᵢ, which is in the range of ˜3000-3500 W/mK at RT. The outcomes of experiments with CNT-based TIMs were controversial. In some cases, K was not improved substantially or even decreased with addition of single-wall CNT. One explanation can be that although CNTs have excellent Kᵢ, they do not couple well to the matrix material or contact surface. Additionally, the CTNs, which were grown from one of the contacting surfaces, did not allow for practical applications in typical industrial environment. Moreover, the high curvature of the CNT surfaces hindered the formation of dense coatings on the CNT.

Industry estimates indicate that increasing TC of TIMs from the present K about 1-12 W/mK to K about 35 W/mK level would produce a major impact on thermal management of various devices resulting in improved performance, reliability and reduced energy consumption. For example, companies would be able to further increase the clock speed of CPUs and increase the power-output and reliability of microwave sources. Increasing TC to about 100 W/mK would produce a revolutionary impact on many industries. The present disclosure provides a TIM with a highly thermally conductivity filler that can increase TC of TIM while keeping other TIM's characteristics such as viscosity, BLT, thermal contact resistance R_{C}, temperature expansion coefficient (TEC) and cost within the industry standards.

The present disclosure provides a revolutionary new method of graphene alignment, which meets all industrial requirements for TIM characteristics and TIM dispersion to the mating surfaces (either via screen printing or dispersion from syringe). The filler including graphene, for example, graphene flakes (including single or multi-layer), obtained by an inexpensive scalable technique or purchased from a vendor, can be functionalized and aligned in a matrix via an external magnetic field. The alignment of the filler will be achieved using functionalization of the graphene surface with magnetic nanoparticles (e.g, Fe₃O₄/γ-Fe₂O₃). The nanoparticles are attached via electrostatic interactions with the intermediate coating layers (as discussed herein). The present disclosure provides a graphene filler alignment process that can be performed during TIM dispersion to mating surfaces via utilization of sample holders with magnets. The magnets of the required strength are available commercially. The viscosity of the matrix materials and solidification time can vary and be adjusted to allow for the alignment of the filler and proper surface attachment.

The previous problems associated with current TIMs are overcome with the present disclosure. For example, the present disclosure provides a method for magnetic functionalization of graphene fillers and provides a method for graphene-filler alignment during TIM dispersion to mating surfaces.

The present disclosure includes a method for the alignment of graphene fillers under magnetic fields. It is based on assembly of magnetic nanoparticles on the surface of graphene fillers. The method combines a polymer wrapping technique (PWT) and a layer-by-layer (LBL) assembly allowing the non-covalent attachment of nanoparticles to the graphene filler leaving intact their structure and thermal properties. The non-covalent bonding can preserve the intrinsically high thermal conductivity of graphene.

In some embodiments, the present disclosure can include treating the graphene filler with a primer and a cationic polyelectrolyte prior to attaching the magnetic nanoparticles. As discussed herein, the primer can be poly-sodium-4-styrene-sulfonate (PSS), which acts as a wrapping polymer providing remarkably stable dispersions of graphene fillers. Owing to the high density of sulfonate groups on the negatively charged polyelectrolyte PSS, the PSS coating acts as a primer on the graphene surface for subsequent homogeneous adsorption of the cationic polyelectrolyte (e.g., poly-dimethyl-diallylammonium chloride (PDDA)) through the electrostatic interactions. The deposited PDDA layer, in its turn, provides a homogeneous distribution of positive charges. The positive charges ensure the efficient adsorption of negatively charged magnetic nanoparticles onto the surface of graphene by means of electrostatic interactions. The magnetic nanoparticles prepared in solution (basic pH) are negatively charged and therefore are electrostatically attracted to the positively charged PDDA layer adsorbed on graphene fillers.

In one embodiment, the magnetic nanoparticles can be attached to the graphene filler without using the primer and the cationic polyelectrolyte. This process leaves free nanoparticle residue but creates sufficient nanoparticles attachment to the graphene filler such that a portion of the magnetically functionalized graphene flakes can be oriented with a magnetic field.

The method of the present disclosure dispersing TIM with self-aligned graphene fillers can be implemented in a typical industrial environment of the assembly plant without drastic changes or major capital investment. Essentially, it only requires placing a flat magnet on the assembly desk or conveyer belt. Thus, as the TIM is dispersed onto a substrate placed on top of the magnet, the graphene filler can self-align during deposition.

FIG. 1 illustrates a schematic illustrating the action of a thermal interface material 10, as constructed in accordance with at least one embodiment. As shown, the TIM 10 fills the gaps between two contacting surfaces 12, 14. The function of the TIM 10 is generally to fill the voids and grooves created by imperfect surface finish of mating surfaces 12, 14. The TMIs 10 performance can be characterized by R_{TIM}=BLT/K+R_{C1}+R_{C2}, where BLT is the bond line thickness and R_{C1}, R_{C2} are the contact resistance of the TIM 10 with the two bounding surfaces 12, 14. The magnitude of R_{TIM} can depend on the surface roughness, interface pressure P, temperature T, and viscosity ξ.

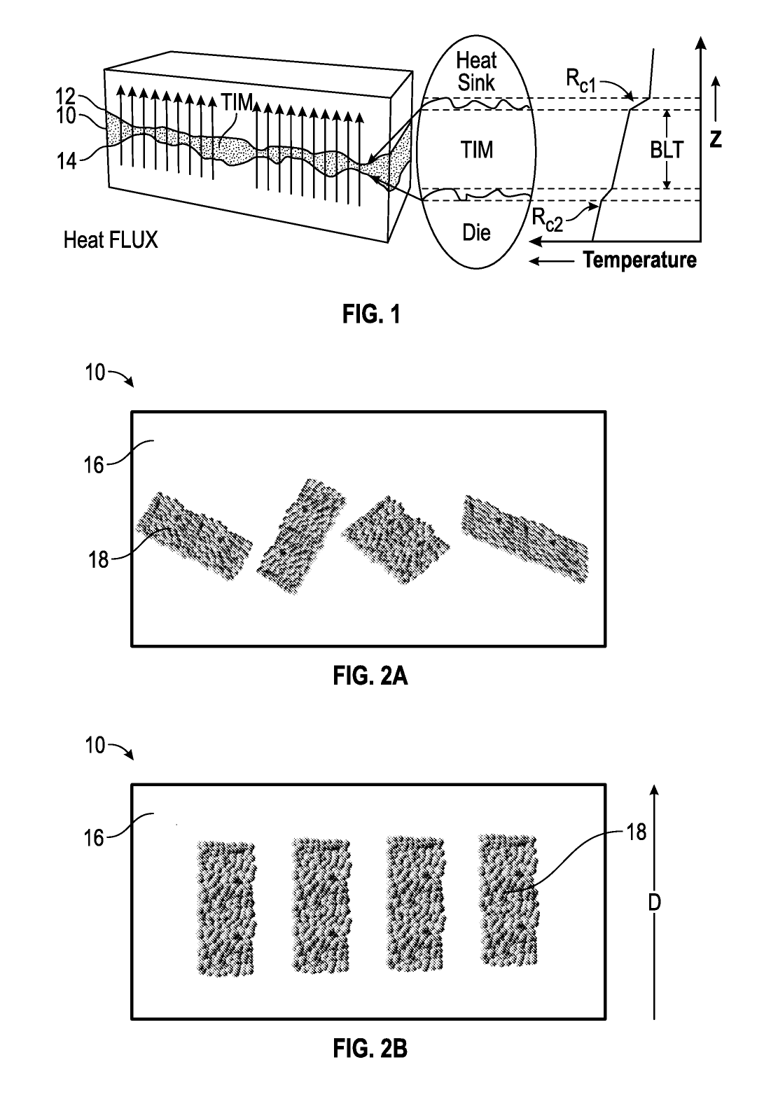

FIG. 2A illustrates an example of a thermal interface material including magnetically functionalized graphene flakes in a random orientation, as constructed in accordance with at least one embodiment. The thermal interface material 10 includes a matrix 16 and a filler 18. The filler 18 can include magnetically functionalized graphene and multilayer graphene (MLG) (referred to herein as “magnetically functionalized graphene flakes” and “magnetically functionalized graphene nanoparticles”) disposed within the matrix 16. The filler 18 of the thermal interface material 10 are configured to be aligned within the matrix 16.

For example, FIG. 2B illustrates an example of a thermal interface material including magnetically functionalized graphene flakes in a specific orientation, as constructed in accordance with at least one embodiment. As seen in FIG. 2B, the specific orientation includes the magnetically functionalized graphene flakes to be arranged in one direction (D) such that a longitudinal axis of the magnetically functionalized graphene flakes are substantially parallel to one another. When the TIM is applied between two substrates, the specific orientation can be perpendicular to the surface of the two substrates. Moreover, the length of the graphene flakes and the BLT can be such that the graphene flakes do not orient parallel to the mating surfaces. When the graphene flakes are parallel to the mating surfaces, the benefits of the aligned fillers can be reduced.

Certain embodiments allow significant improvement of the heat conduction properties. For example, the aligned magnetically functionalized graphene flakes can be used to enhance the cross-plane (through-plane) thermal conductivity K of a TIM.

In some embodiments, the matrix 16 can include any matrix material used for thermal interface materials. For example, in some embodiments, the matrix 16 can include a polymer, e.g., an epoxy, a silicone, polystyrene, or polymethyl methacrylate (PMMA). In other embodiments, the matrix 10 can include thermal grease, oil, or glycol and paraffin. Other matrix materials known in the art or yet to be developed can be used. The matrix materials can also include additional fillers, such as metal nanoparticles such as silver or aluminum or semiconductor nanoparticles such as zinc oxide.

In some embodiments, the filler 18 include graphene such as magnetically functionalized graphene flakes (including single or multi-layer flakes). The thermal interface material 10 can include less than or equal to about 50 volume % of the filler 18 (e.g., between about 0.5 volume % and about 40 volume %, between about 0.5 volume % and about 30 volume %, between about 0.5 volume % and about 25 volume %, between about 0.5 volume % about 20 volume %, between about 0.5 volume % and about 15 volume %, between about 0.5 volume % and about 10 volume %, or between about 0.5 volume % and about 5 volume % of the filler 120). As described herein, certain embodiments of the thermal interface material 10 can have improved heat conduction properties by only adding less than or equal to about 25 volume % (e.g., between about 0.5 volume % and about 15 volume %, between about 0.5 volume % and about 10 volume %, or between about 0.5 volume % and about 5 volume %) of the filler 18 including the magnetically functionalized graphene flakes

As discussed herein, magnetic nanoparticles are attached to the filler (e.g., the single or multi-layer graphene flakes) such that the filler can be oriented by an applied magnetic field. As shown herein, a drastic increase in thermal conductivity with small or moderate filler loading can be achieved if the fillers are aligned along one direction. The direction of alignment should be perpendicular to the mating surfaces, facilitating the heat transfer from one mating surface to another.

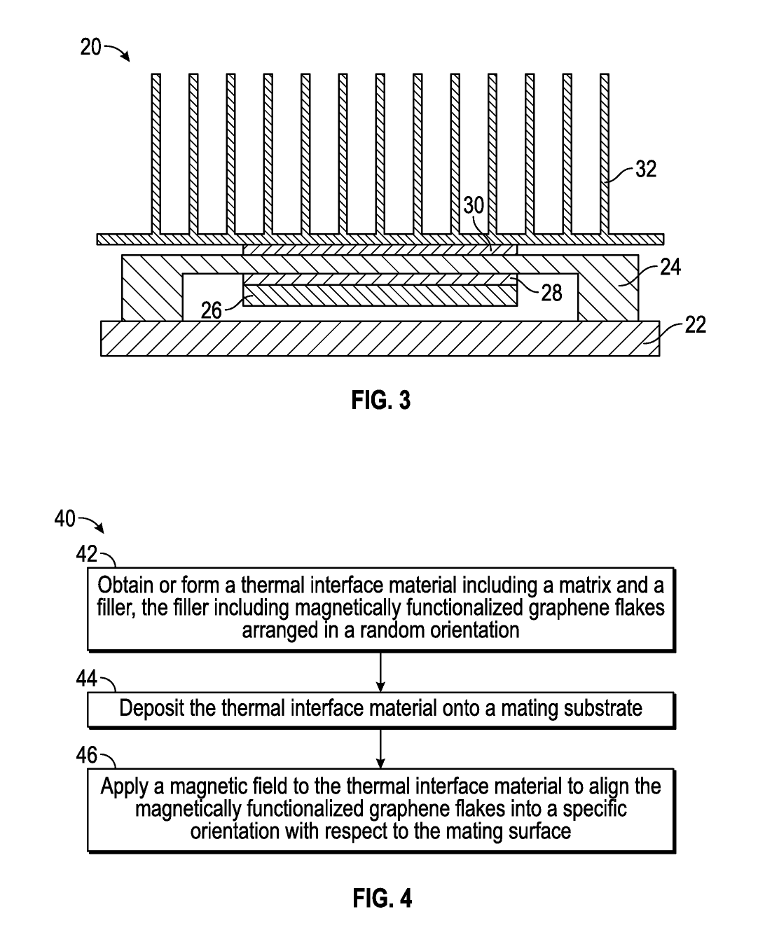

FIG. 3 illustrates a cross-sectional view of an example packaging architecture 20 for a personal computer including a thermal interface material 28, 30, as constructed in accordance with at least one embodiment. The packaging architecture 20 can include a package substrate 22 including an attached chip 26, an integrated heat spreader 24, and a heat sink 32. As seen in FIG. 3, a layer of TIM 28 is used between the chip 26 and the integrated heat spreader 24 and a layer of TIM 30 is used between the integrated heat spreader 24 and the heat sink 32.

FIG. 4 illustrates a method 40, as constructed in accordance with at least one embodiment. The method 40, at step 42, can include obtaining or forming a thermal interface material including a matrix and a filler, the filler including magnetically functionalized graphene flakes arranged in in a random orientation, at step 44, can include depositing the thermal interface material onto a mating substrate, and at step 44, can include applying a magnetic field to the thermal interface material to align the magnetically functionalized graphene flakes into a specific orientation with respect to the mating substrate.

The method can include obtaining or forming the magnetically functionalized graphene flakes. As discussed herein, the graphene flakes used for the filler can be formed or purchased from a vendor.

In general, graphene is a single atomic plane of sp²-bound carbon. Graphene has an extremely high intrinsic thermal conductivity Kᵢ, which exceeds that of carbon nanotubes (CNTs). Multilayer graphene (MLG) retains good thermal properties. Graphite, which is 3D bulk limit for MLG with the number of layers n→∞), is still generally an excellent heat conductor with Kᵢ≈2000 W/mK at RT. For comparison, Kᵢ≈430 W/mK for silver and it is much lower for silver nanoparticles used in TIMs.

In certain embodiments, the graphene nanoparticles (e.g, graphene flakes) can have a length within a range of about 10 nanometers (nm) to about 100 micrometers (μm). In another embodiment, the length of the graphene nanoparticles is within a range of about 100 nm to about 20 μm. In another embodiment, the length is within a range of about 500 nm to about 10 μm. In certain embodiments, the thickness of the graphene nano-particle can be within a range of about 0.35 nm (single graphene layer) to about 100 nm. In an embodiment, the filler can include a combination of graphene nanoparticles having different thicknesses. In one embodiment, 10% of the thickness can be below 0.7 nm (2 atomic layers), 50% of the thicknesses can be below 2 nm, and 40% of the thicknesses can be below 10 nm.

In some embodiments, at least about 50% of the graphene nanoparticles can have a thickness between about 0.35 nm to about 2.5 nm (e.g., between about 1 and about 7 atomic planes), between about 0.35 nm to about 2 nm (e.g., between about 1 and about 6 atomic planes), between about 0.35 nm and about 1.5 nm (e.g., between about 1 and about 4 atomic planes), or between about 0.35 nm and about 1 nm (e.g., between about 1 and about 3 atomic planes). As other embodiments, about 10%, about 20%, about 30% or about 40% of the MLG can have a thickness between about 0.35 nm and about 2.5 nm (e.g., between about 1 and about 7 atomic planes), between about 0.35 nm and about 2 nm (e.g., between about 1 and about 6 atomic planes), between about 0.35 nm and about 1.5 nm (e.g., between about 1 and about 4 atomic planes), or between about 0.35 nm and about 1 nm (e.g., between about 1 and about 3 atomic planes). Various combinations are possible.

In various embodiments, the graphene nanoparticles can have an aspect ratio greater than or much greater than one. For example, the lateral dimension L for various graphene nanoparticles can be within the range of about 3.5 nanometers to about 10 micrometers (e.g., within the range of about 5 nanometers to about 10 micrometers or within the range of about 5 nanometers to about 5 micrometers). Furthermore, the graphene nanoparticles can include a combination of graphene nanoparticles with different lateral dimensions. For example, about 90% or at least about 90% of the graphene nanoparticles can have an L within the range of about 25 nanometers to about 1 micrometer (e.g., within the range of about 50 nanometers to about 0.5 micrometer). At least about 10% of the graphene nanoparticles can have an L greater than 1 micrometer and less than or equal to about 10 micrometers (e.g., between about 10% to about 15% of the graphene nanoparticles can have an L within the range of about 2 nanometers to about 5 micrometers). Various combinations are possible.

As discussed herein, the graphene nanoparticles can be produced or purchased. Graphene dispersions can be prepared by ultrasonication of inexpensive natural graphite in a solution of sodium cholate followed by sonication and centrifugation. The solution will be allowed to settle followed by removal of thick graphite flakes The sonicated solution will be then subject to sedimentation processing in a centrifuge. The speed of centrifugation (RPM) and time of centrifugation, t_{C}, determine the degree of exfoliation, i.e. average thickness and lateral dimensions of the flakes. Reducing RPM and t_{C} will result in graphite particles or nano-platelets, which still can be used as fillers in lower grade less-expensive TIMs. The matrix material will be added to complete the composite preparation. The unavoidable variability in graphene size and thickness do not strongly affect TC of TIMs. The proper selected RPM and t_{C} will provide substantial concentration of single layer, bi- and multi-layer graphene flakes with few-μm lateral dimensions.

The method 40 can include magnetically functionalizing the produced or purchased graphene nanoparticles (e.g., graphene flakes). The method 40 can include combining a primer and a graphene solution including graphene flakes to form a primer solution, combining a cationic polyelectrolyte and the primer solution to form a charged graphene solution, and combining magnetic nanoparticles and the charged graphene solution to form a magnetic solution. In another embodiment, magnetically functionalizing the graphene nanoparticles includes combining the magnetic nanoparticles with the graphene solution.

As discussed herein, the method of preparing the magnetically functionalized graphene flakes is implemented with the use of magnetic nanoparticle solution and two chemical treatment steps. In one embodiment, the magnetic nanoparticles used were acquired from FerroTec (EMG1300: diameter: 10 nm; iron oxide content: 60-80%; magnetization: 50-70 emu/g; tested solutions: Toluene, Heptane, Xylene). The optimum magnetic nanoparticles are selected based on SEM data, magnetization measurements, thermal tests and cost. As discussed herein the graphene that is subsequently magnetically functionalized can be produced or can be bought from commercial vendors, e.g. Graphene Laboratories. In addition to graphene-FGL fillers, the technology can be extended to thicker nm-μm range graphite filers. Alignment of thicker graphite fillers can pave the way for even less expensive TIMs, which still have TC exceeding that of commercial TIMs. The method will require accurate control of composition, viscosity, temperature and processing time to allow for proper graphene filler alignment under selected magnetic field intensity.

In the embodiment where the two chemical treatments are used (e.g., the primer and the cationic polyelectrolyte), the primer can “wrap” the surfaces of the graphene nanoparticles with a positive charge. The cationic polyetrolyte can then “wrap” the primer surface on the graphene nanoparticles with a negative charge. Once the magnetic nanoparticles are added, magnetites can attach electrostatically to the graphene nanoparticles.

The method 40 can include mixing the magnetic solution and the matrix to form the thermal interface material including the magnetically functionalized graphene flakes The method 40 can further include providing or obtaining a magnet on an assembly desk, and placing the mating substrate on a top surface of the magnet. A magnetic field can be applied to the thermal interface material simultaneously as the thermal interface material is deposited onto the mating substrate. In one embodiment, the magnetic field can be applied to the thermal interface material after the thermal interface material is deposited onto the mating substrate. When the magnetically functionalized graphene flakes are in the specific orientation, a majority of the magnetically functionalized graphene flakes are substantially perpendicular to the top surface of the mating substrate. Method 40 can also include waiting a time period to allow for partial solidification of the layer of the thermal interface material and depositing a second mating substrate onto a top surface of the layer of the thermal interface material.

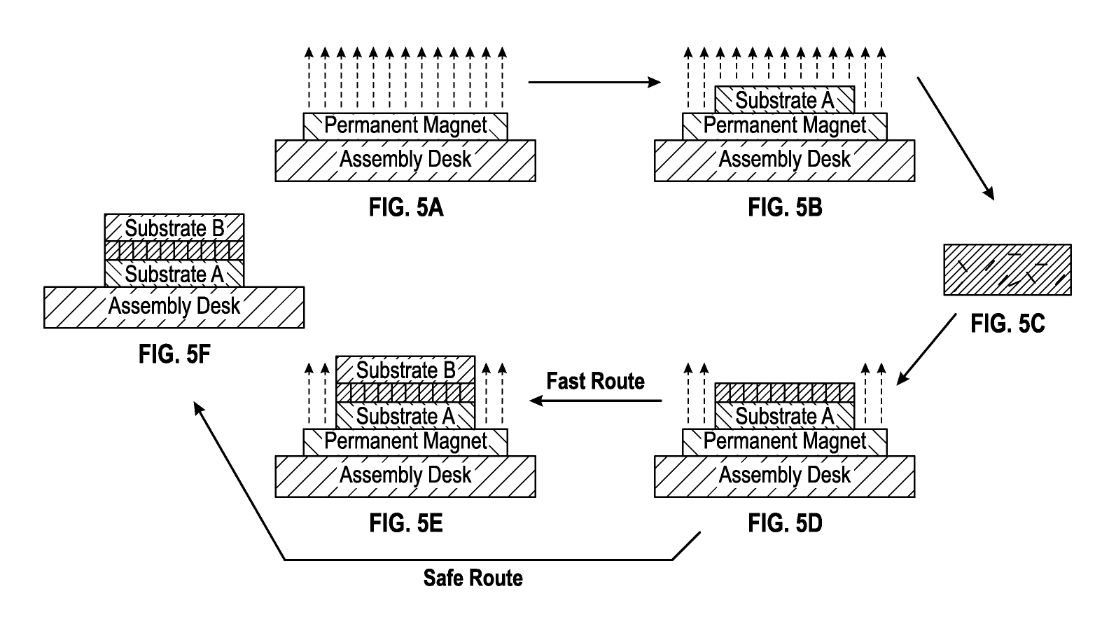

FIGS. 5A-5F illustrate an example method of assembly. FIG. 5A illustrates an example of an assembly desk and a magnet. The magnet can have a field intensity, H, ranging from ˜0.2 to 3.5 T. FIG. 5B illustrates an example of a first substrate (e.g., a heat spreader) placed on top of the magnet. FIG. 5C illustrates an example of a thermal interface material including the magnetically functionalized graphene flakes in a random orientation. FIG. 5D illustrates an example of the thermal interface material in FIG. 5C deposited onto the first substrate, where the magnetically functionalized graphene flakes have been aligned to have a specific orientation. The TIM can be dispersed from a syringe in a manual assembly process or screen printed in the high-volume production. The strength of the magnetic field is such that magnetically-functionalized fillers undergo fast alignment (time-scale is from a few seconds to minutes). The time can be controlled via tuning the viscosity and T of TIM or magnetic field. FIG. 5E illustrates an example of a second substrate (e.g., a chip) being placed onto a surface of the thermal interface material. If exposure of the second substrate to a magnetic field is undesirable, FIG. 5F illustrates another method where the first substrate can be removed from the magnet or the magnet can be removed from the assembly deck and subsequently attaches the second substrate to a surface of the TIM. This would involve extra time to allow for partial solidification of TIM so that fillers preserve their specific orientation.

### EXAMPLES SECTION

In the Examples section experimental evidence is provided for the method of aligning graphene fillers. The predicted enhancement of the thermal diffusivity and thermal conductivity via ordering of magnetically functionalized graphene fillers has been observed.

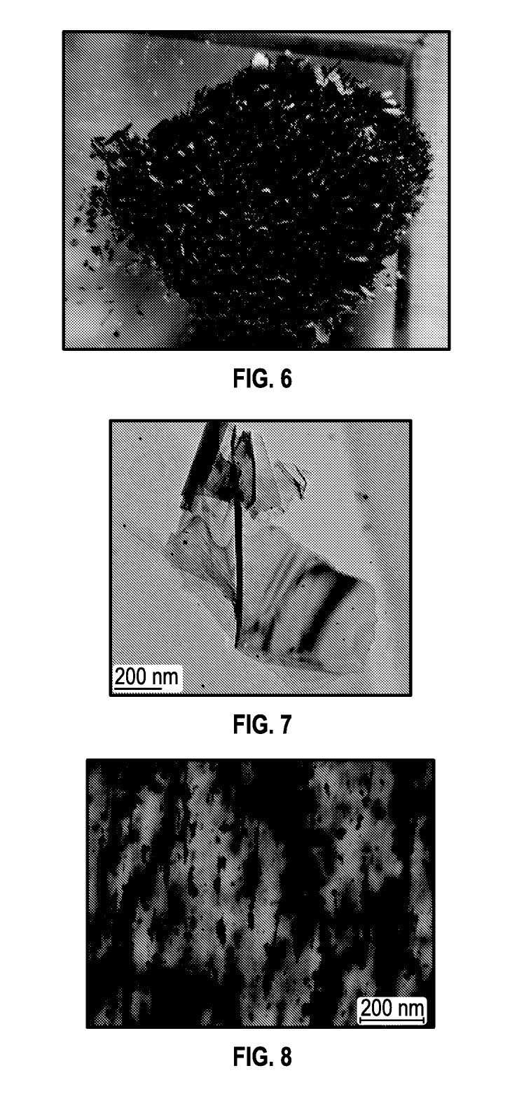

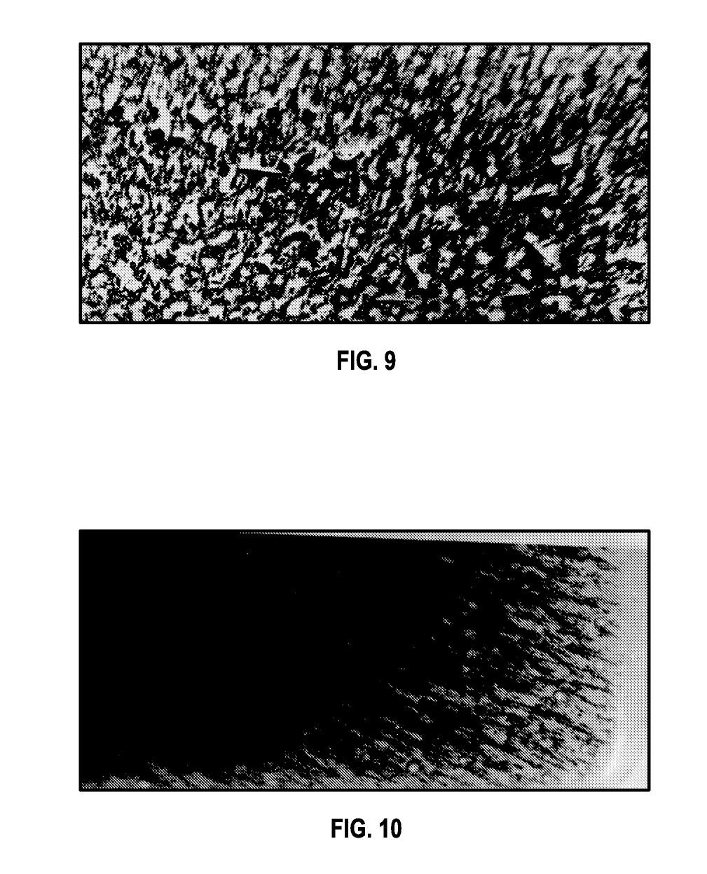

Graphene fillers were produced and FIG. 6 illustrates a photograph of graphene fillers including graphene-graphite fillers aligned by a magnetic field. The fillers are placed on top of a thick glass and the magnet is behind the glass. As seen in FIG. 6, the filler particles “standing up.” FIG. 7 illustrates a scanning electron microscopy (SEM) image of a graphene flake with attached magnetic nanoparticles. The magnetic nanoparticles are seen as black dots. FIG. 8 illustrates a SEM image of the magnetically functionalized graphene flakes aligned within an epoxy matrix. Further, FIG. 9 illustrates a SEM image of an epoxy-based thermal interface material with magnetically functionalized graphene flakes arranged in a random orientation. FIG. 10 illustrates a SEM image of the epoxy-based thermal interface material with the magnetically functionalized graphene flakes arranged in a specific orientation.

### Materials

Graphene nanoparticles (flakes): average flake thickness of about 12 nm and an average lateral size of about 4500 nm.

PDDA: Poly(diallyldimethylammonium) chloride; average Mw 400,000-500,000, 20 wt % in H₂0.

PSS: Poly(sodium 4-styrenesulfonate); average Mw ˜1,000,000, powder.

PSS Solution: 1 wt % aqueous solution of PSS.

PDDA Solution: 2.5 wt % aqueous solution of PDDA.

Ferro Fluid: Magnetite, black iron oxide mineral, Fe₃O₄, EMG 700, 50 cc, M080613C, Nominal particle diameter: 10 nm.

### Formation of Examples

The following Examples and Comparative Examples were formed and used for testing to determine the affect for the self-aligning fillers disclosed herein.

### Forming Magnetically Functionalized Graphene Flakes

Graphene nanoparticles (flakes) were weighted. PSS solution was added to graphene flakes, which treats or “wraps” the graphene surfaces with PSS (positive charge). Excess traces of PSS were removed by rinsing with DI water. Add PDDA solution to PSS-treated graphene flakes which treats or “wraps” the PSS surface with PDDA (negative charge). Excess traces of PDDA were removed by rinsing with DI water. One to 10 cc of ferrofluid is added to decanted PDDA-PSS-treated graphene flakes. Solution was desiccated and magnetites from ferrofluid and attach themselves electrostatically to the graphene flakes.

After adding ferrofluid to treated PDDA-PSS-graphene flakes, it is ready for drying in the vacuum oven. The solution was placed in glass petri dishes for desiccating in a vacuum oven at 40° C. The dried solution is scraped from the petri dishes. The magnetically functionalized graphene flakes in power form can be mixed with matrix material.

### Example 1

The magnetically functionalized graphene flakes are added to an epoxy under a magnetic field to form a TIM with 1 wt % of the magnetically functionalized graphene flakes having a specific orientation.

### Example 2

The magnetically functionalized graphene flakes are added to an epoxy under a magnetic field to form a TIM with 4 wt % of the magnetically functionalized graphene flakes having a specific orientation positioned between a copper/copper interface.

### Example 3

The magnetically functionalized graphene flakes are added to a thermal paste under a magnetic field to form a TIM with the magnetically functionalized graphene flakes having a specific orientation.

### Example 4

The magnetically functionalized graphene flakes are added to a thermal paste under a magnetic field to form a TIM with 20 wt % of the magnetically functionalized graphene flakes having a specific orientation.

### Example 5

The magnetically functionalized graphene flakes are added to an epoxy under a magnetic field to form a TIM with 2 wt % of the magnetically functionalized graphene flakes having a specific orientation.

### Comparative Example A

An epoxy

### Comparative Example B

An epoxy including 1 wt % of the of the magnetically functionalized graphene flakes having a random orientation.

### Comparative Example C

An epoxy including 4 wt % of the of the magnetically functionalized graphene flakes having a random orientation.

### Comparative Example D

Conventional TIM

### Comparative Example E

Conventional Paraffin Thermal Paste

### Comparative Example F

Ice Fusion

### Comparative Example G

Boron Nitride with 4 wt % of the magnetically functionalized graphene flakes having a random orientation.

### Comparative Example H

An epoxy including 2.4 wt % of the of the magnetically functionalized graphene flakes having a random orientation.

### Tests

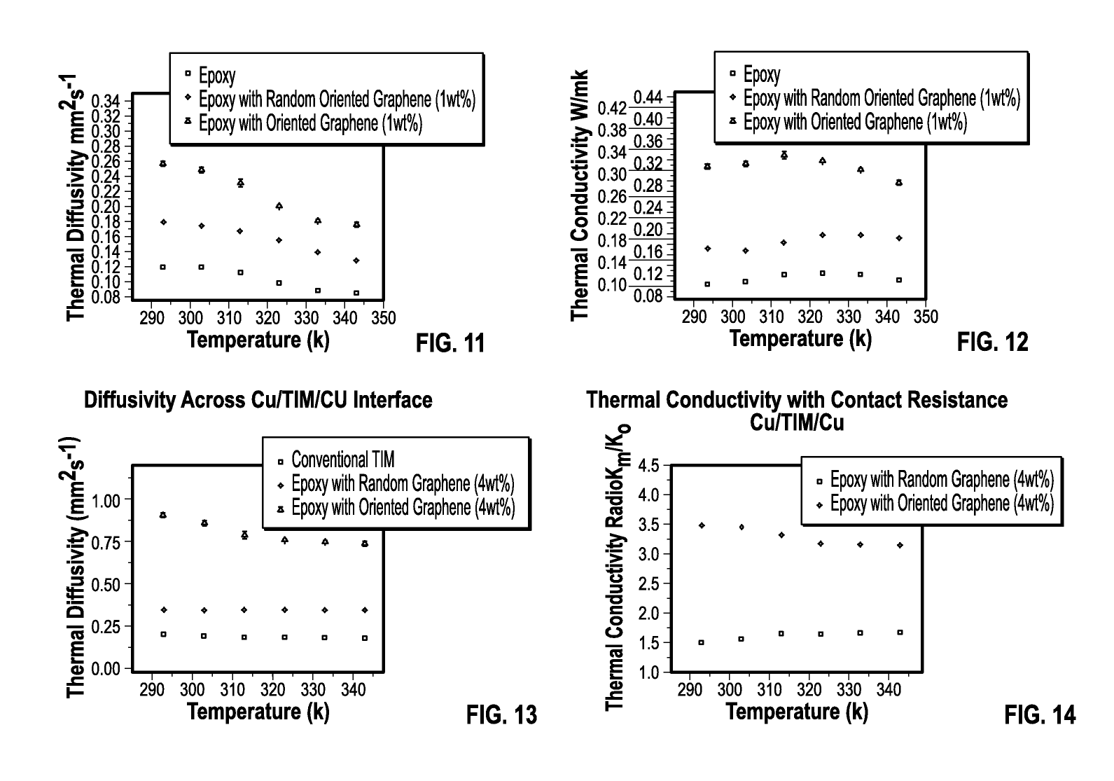

Thermal characterization of the TIMS for the above Examples and Comparative Examples are determined using three different experimental techniques (“laser flash”, “hot “disk”, and TIM Tester). The results are shown in FIGS. 11-19 and discussed below. The measurements of thermal conductivity, K, were performed by the transient “laser flash” technique (LFT, NETZSCH LFA). The LFT technique uses a xenon flash lamp, which heats the sample from one end by producing shots with energy of 10 J/pulse. The integrated automatic sample changer allowed unattended analysis of up to 4 samples. The temperature rise was determined at the back end with the nitrogen-cooled InSb IR detector. The output of the temperature detector was amplified and adjusted for the initial ambient conditions. The recorded temperature rise curve is the change in the sample temperature resulting from the firing of the flash lamp. The magnitude of the temperature rise and the amount of the light energy are not used for a diffusivity determination; only the shape of the curve is used in the analysis. From the analysis of the resulting temperature versus-time curve the thermal diffusivity can be determined. For the specific heat measurement, the magnitude of the temperature rise of an unknown sample was compared to that of the reference calibration sample. Thermal conductivity was determined from the equation K=ραCₚ, where α is the thermal diffusivity of the film determined in the experiment, Cₚ is the heat capacity, and ρ is the mass density of the material. As disclosed herein, the example embodiments of TIMs allow significant improvement of heat conduction properties.

### Results

FIG. 11 illustrates the thermal diffusivity of Example 1 (Epoxy with Oriented Graphene 1 wt %), Comparative Example A (Epoxy), and Comparative Example B (Epoxy with Random Oriented Graphene 1 wt %). FIG. 12 illustrates the thermal conductivity of Example 1 (Epoxy with Oriented Graphene 1 wt %), Comparative Example A (Epoxy), and Comparative Example B (Epoxy with Random Oriented Graphene 1 wt %). The thermal diffusivity and thermal conductivity as functions of temperature for TIMS with random and aligned graphene fillers are shown. The thermal properties of aligned-filler materials are much stronger enhanced compared to the random orientation, even at small graphene loading fraction of 1 wt %.

FIG. 13 illustrates the thermal diffusivity of Example 2 (Epoxy with Orientated Graphene 4 wt %), Comparative Example C (Epoxy with Ramdon Graphene 4 wt %), and Comparative Example D (Conventional TIM). FIG. 14 illustrates the thermal conductivity ratio of Example 2 (Epoxy with Orientated Graphene 4 wt %) and Comparative Example C (Epoxy with Ramdon Graphene 4 wt. The apparent thermal diffusivity data showing that TIMs with only 4% of oriented graphene fillers outperform conventional TIMs by ×4 factor; the apparent thermal conductivity data proving that TIMs with oriented graphene fillers substantially outperform TIMs with randomly mixed graphene TIMs. The apparent thermal diffusivity/conductivity data includes the effect of the thermal contact resistance with the specific mating surfaces—one of the metrics suggested by a major TIM end-user.

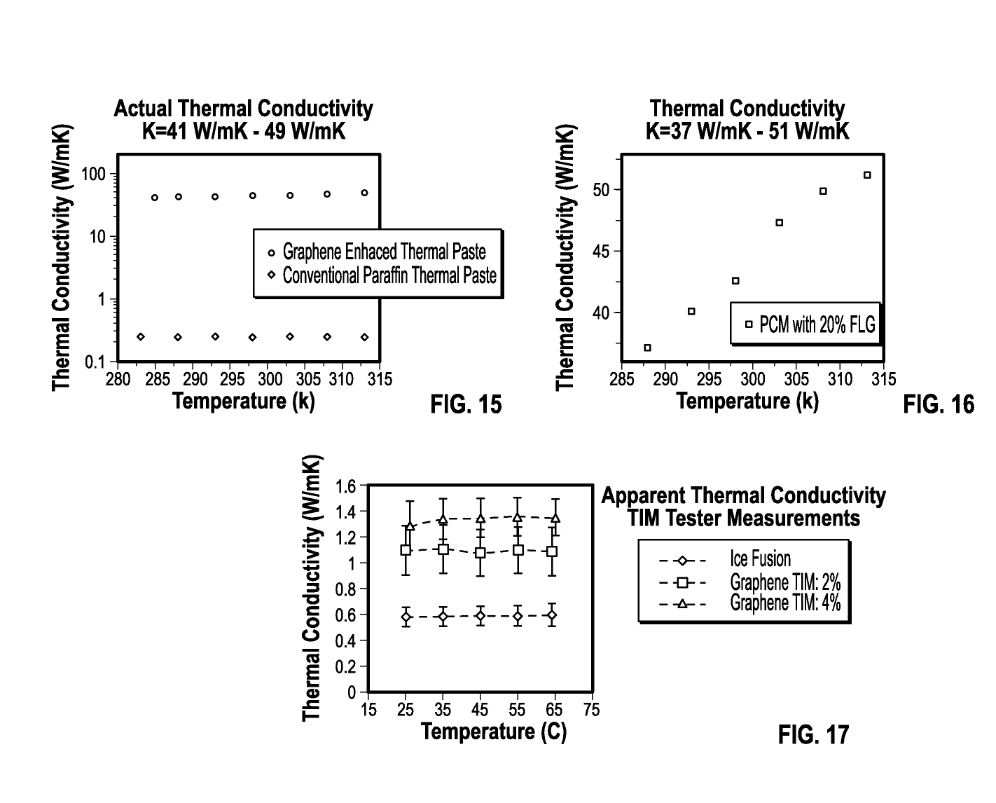

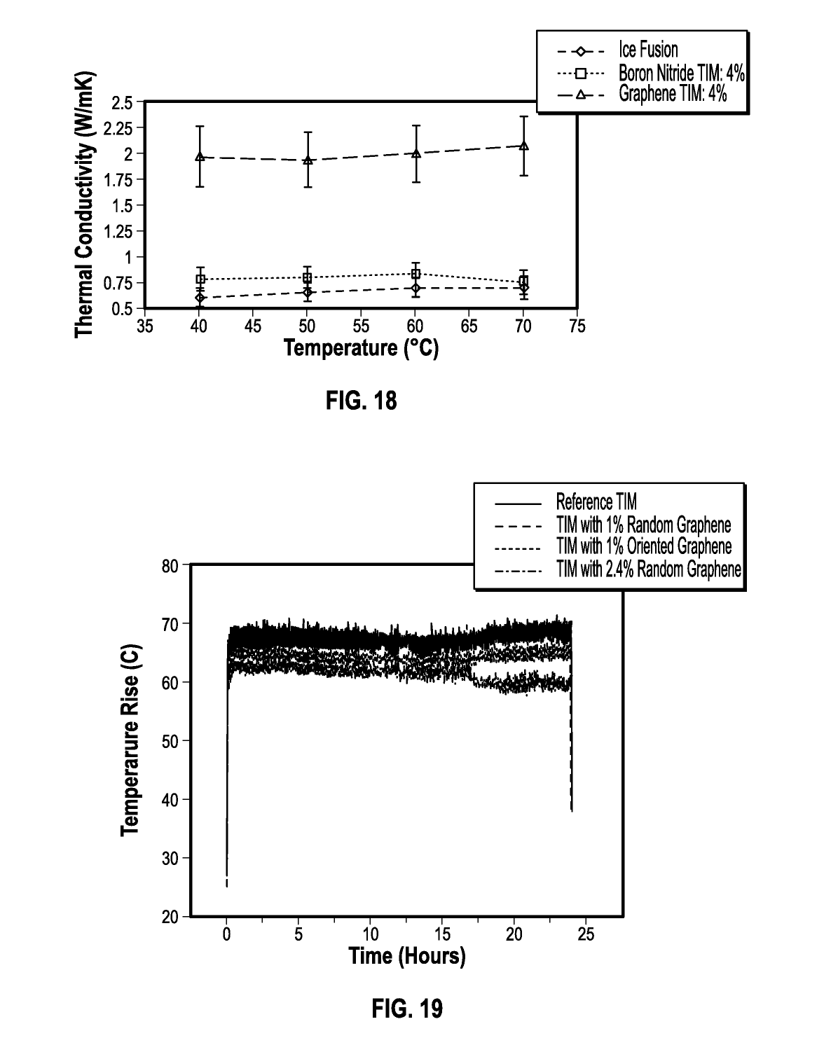

FIG. 15 illustrates the thermal conductivity of Example 3 (Graphene enhanced thermal paste) and Comparative Example D (Conventional Paraffin Thermal Paste). FIG. 16 illustrates the thermal conductivity of Example 4 (thermal paste with 20 wt % of graphene aligned). FIG. 17 illustrates the apparent thermal conductivity of Example 2 (Graphene 4 wt % aligned), Example 5 (Graphene 2 wt % aligned), and Comparative Example F (Ice Fusion). FIG. 18 illustrates the apparent thermal conductivity of Example 2 (Graphene 4 st %; aligned), Comparative Example F (Ice Fusion), and Comparative Example G (Boron Nitride with 4 wt % of graphene; random).

As shown, the measured thermal conductivity of thermal paste with graphene is grater than the conventional paraffin thermal paste. Further, the thermal conductivity of PCM with the large loading of FLG showing strong increase owing to the onset of phase transition. The apparent thermal conductivity of PCM with graphene (2% and 4%) in comparison to the best market TIM (IceFusion), illustrates that the graphene aligned fillers illustrate improvement over the market TIM. The apparent thermal conductivity of graphene enhanced TIM in comparison with the BN enhanced TIM and the reference commercial TIM (IceFusion). The apparent thermal conductivity data includes the effect of the thermal contact resistance with the specific mating surfaces (Si and Cu), which explains the relatively low absolute values. Note that the absolute values of ˜50 W/mK in larger size PCM samples with graphene present the record high.

For large and thick samples (e.g., PCMs or epoxy) the thermal contact resistance does not affect the results substantially and one can use the actual TC data. For TIMs with BLT in μm range one should use the apparent TC value, which includes the thermal contact resistance, R_{C}. One can see that the graphene aligned enhanced TIMs can reach values above 50 W/mK at room temperature. This is very high value compared to conventional PCMs (typically around 0.2-1.0 W/mK). The thermal conductivity of PCM with the large loading of FLG shows strong increase owing to the onset of phase transition. The apparent thermal conductivity of graphene enhanced TIMs consistently shows much higher value than the best commercial TIMs. The absolute values of the apparent conductivity are smaller due to the effect of the thermal contact resistance.

FIG. 19 illustrates the temperature rise as a function of hours for Example 1 (TIM with 1 wt % aligned graphene), Comparative Example B (TIM with 1 wt % random graphene), Comparative Example H (TIM with 2.4 wt % random graphene), and Comparative Example D (Conventional TIM). The temperature rise is a function of hours under heavy duty operation for CPUs attached with oriented graphene TIM (1% loading), random graphene TIM (1% and 2.4% loading) and reference commercial TIM used by industry. Note that the 10° C. reduction is substantial by industry standards.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method, comprising:
obtaining or forming a thermal interface material including a matrix and a filler, the filler including magnetically functionalized graphene flakes arranged in in a random orientation;
depositing the thermal interface material onto a mating substrate; and
applying a magnetic field to the thermal interface material to align the magnetically functionalized graphene flakes into a specific orientation with respect to the mating substrate.

2. The method of claim 1, wherein forming the thermal interface material includes:
combining a primer and a graphene solution including graphene flakes to form a primer solution;
combining a cationic polyelectrolyte and the primer solution to form a charged graphene solution; and
combining magnetic nanoparticles and the charged graphene solution to form a magnetic solution.

3. The method of claim 2, further including:
mixing the magnetic solution and the matrix to form the thermal interface material including the magnetically functionalized graphene flakes.

4. The method of claim 3, wherein the matrix material is selected from one of a polymer, an epoxy, and thermal grease.

5. The method of claim 2, wherein the primer is poly-sodium-4-styrene-sulfonate and the cationic polyelectrolyte is poly-dimethyl-diallylammonium chloride.

6. The method of claim 1, further including:
providing or obtaining a magnet on an assembly desk; and
placing the mating substrate on a top surface of the magnet.

7. The method of claim 1, wherein the magnetic field is applied to the thermal interface material simultaneously as the thermal interface material is deposited onto the mating substrate.

8. The method of claim 1, wherein the magnetic field is applied to the thermal interface material after the thermal interface material is deposited onto the mating substrate.

9. The method of claim 1, wherein, when the magnetically functionalized graphene flakes are in the specific orientation, a majority of the magnetically functionalized graphene flakes are substantially perpendicular to the top surface of the mating substrate.

10. The method of claim 1, wherein the mating substrate is a first mating substrate, the method further includes:
waiting a time period to allow for partial solidification of the layer of the thermal interface material; and
depositing a second mating substrate onto a top surface of the layer of the thermal interface material.

11. A device, comprising:
a first mating substrate having a top surface;
a second mating substrate having a bottom surface; and
a thermal interface material positioned between and in direct contact with the top surface of the first mating substrate and the bottom surface of the second mating substrate, the thermal interface material including:
a matrix; and
a filler including magnetically functionalized graphene flakes, the magnetically functionalized graphene flakes arranged in a specific orientation with respect to the top surface and the bottom surface.

12. The device of claim 11, wherein the thermal interface material includes the magnetically functionalized graphene flakes within a range of about 0.5 volume percent to about 25 volume percent, based on a total volume of the thermal interface material.

13. The device of claim 11, wherein a length of the magnetically functionalized graphene flakes is within a range of about 10 nanometers to about 100 micrometers micrometer to about 25 nanometers.

14. The device of claim 11, wherein a thickness of the magnetically functionalized graphene flakes is within a range of about 0.35 nanometers to about 100 nanometers.

15. The device of claim 11, wherein 10 percent of the magnetically functionalized graphene flakes have a thickness below 0.7 nanometers, 50 percent of the magnetically functionalized graphene flakes have a thickness below 2 nanometers, and 40 percent of the magnetically functionalized graphene flakes have a thickness below 10 nanometers.

16. The device of claim 11, wherein the magnetically functionalized graphene flakes includes magnetic nanoparticles, the magnetic nanoparticles having a diameter within a range of about 6 micrometers to about 10 micrometers.

17. A thermal interface composition, comprising:
a matrix; and
a filler material including magnetically functionalized graphene flakes arranged in a random orientation, the magnetically functionalized graphene flakes configured to align into a specific orientation with respect to a substrate when a magnetic field is applied to the thermal interface composition.

18. The thermal interface composition of claim 17, wherein the thermal interface composition includes the magnetically functionalized graphene flakes within a range of about 0.5 volume percent to about 25 volume percent, based on a total volume of the matrix and the filler material.

19. The thermal interface composition of claim 17, wherein the magnetically functionalized graphene flakes include magnetic nanoparticles having a diameter within a range of about 6 nanometers to about 10 nanometers.

20. The thermal interface composition of claim 17, wherein 10 percent of the magnetically functionalized graphene flakes have a thickness below 0.7 nanometers, 50 percent of the magnetically functionalized graphene flakes have a thickness below 2 nanometers, and 40 percent of the magnetically functionalized graphene flakes have a thickness below 10 nanometers.
